(19) United States
(12) Patent Application Publication
(10) Pub. No.: US 2024/0090703 A1
(43) Pub. Date: Mar. 21, 2024

(54) CORDLESS BLENDING APPLIANCE

(71) Applicant: WHIRLPOOL CORPORATION, BENTON HARBOR, MI (US)

(72) Inventors: Antonius K. Aditjandra, St. Joseph, MI (US); Richard D. Arnold, St. Joseph, MI (US); Lynsey A. Howse, St. Joseph, MI (US); Rebecca K. Kasner, St. Joseph, MI (US); Brandon Tyler Mock, St. Joseph, MI (US); John Jay Myers, Saugatuck, MI (US); Nicholas Hill Schutte, St. Joseph, MI (US); Yifan Wang, Benton Harbor, MI (US); Rex D. Wilson, Stevensville, MI (US)

(73) Assignee: WHIRLPOOL CORPORATION, BENTON HARBOR, MI (US)

(21) Appl. No.: 18/458,590

(22) Filed: Aug. 30, 2023

Related U.S. Application Data
(60) Provisional application No. 63/407,863, filed on Sep. 19, 2022.

(51) Int. Cl. A47J 43/046; A47J 43/07; A47J 43/08

(52) U.S. Cl. CPC A47J 43/046; A47J 43/0722; A47J 43/085

(57) ABSTRACT

A cordless appliance includes a blender having a base unit with a housing and an upwardly opening upper cavity. A drive connection is positioned within the upwardly opening upper cavity. The housing further includes a battery-receiving cavity that is configured to receive a removable battery. A motor is disposed within the housing of the base unit it is contemplated to be powered by the removable battery. A blender jar includes an upper collar in an interior cavity. A first lid assembly is configured to be coupled to the upper collar of the blender jar and includes a blade assembly and a drive connecting member. A second lid assembly includes a cap member removably received on an open aperture of the second lid assembly. The first and second lid assemblies are configured for limited rotation with respect to the blender jar for engagement of the same.

### CROSS-REFERENCE TO RELATED APPLICATION

This application claims priority to and the benefit under 35 U.S.C. § 119(e) of U.S. Provisional Patent Application No. 63/407,863, filed on Sep. 19, 2022, entitled CORDLESS BLENDING APPLIANCE, the disclosure of which is hereby incorporated by reference in its entirety.

### BACKGROUND OF THE DISCLOSURE

The present disclosure generally relates to a blending appliance, and more specifically, to a cordless blending appliance.

### SUMMARY OF THE DISCLOSURE

According to one aspect of the present disclosure, a cordless appliance includes a blender having a base unit with a housing and an upwardly opening upper cavity. A drive connection is positioned within the upwardly opening upper cavity. The housing further includes a battery-receiving cavity that is configured to receive a removable battery. A motor is disposed within the housing of the base unit it is contemplated to be powered by the removable battery. A blender jar includes an upper collar in an interior cavity. A first lid assembly is configured to be coupled to the upper collar of the blender jar and includes a blade assembly and a drive connecting member. A second lid assembly includes a cap member removably received on an open aperture of the second lid assembly. The first and second lid assemblies are configured for limited rotation with respect to the blender jar for engagement of the same.

According to one aspect of the present disclosure, an appliance includes a base unit having a housing with an upwardly opening upper cavity with a drive connection positioned therein. The housing further includes a battery-receiving cavity. A motor is disposed within the housing of the base unit. A blender jar includes an upper collar and an interior cavity. A first lid assembly removeably couples to the upper collar of the blender jar and the upwardly opening upper cavity of the base unit. The first lid assembly includes a drive connecting member disposed on a first side thereof and a blade assembly disposed on a second side thereof. The drive connecting member engages the drive connection of the base unit when the first lid assembly is coupled to the upwardly opening upper cavity of the base unit. A battery is removably received within the battery-receiving cavity for powering the motor of the base unit.

According to another aspect of the present disclosure, an appliance includes a base unit having a housing with an upwardly opening upper cavity with a drive connection positioned therein. The housing further includes a battery-receiving cavity. A motor is disposed within the housing of the base unit. A blender jar includes an upper collar and an interior cavity. A lid assembly includes first and second collars disposed on opposite sides of a divider. The first collar surrounds a drive connecting member positioned on a first side of the divider and is removeably coupled to the upper cavity of the base unit. The second collar surrounds a blade assembly on a second side of the divider and is removeably coupled to the upper collar of the blender jar. The drive connecting member engages the drive connection of the base unit when the lid assembly is coupled to the upwardly opening upper cavity of the base unit at the first collar thereof. The appliance further includes a battery removably received within the battery-receiving cavity for powering the motor of the base unit.

According to still another aspect of the present disclosure, an appliance includes a base unit having a housing with an upwardly opening upper cavity with a drive connection positioned therein. The housing further includes a battery-receiving cavity. A motor is disposed within the housing of the base unit. A blender jar includes an upper collar and an interior cavity. A lid assembly includes first and second collars disposed on opposite sides of a divider. The first collar surrounds a drive connecting member positioned on a first side of the divider and is configured to be coupled to the upper cavity of the base unit. The second collar surrounds a blade assembly on a second side of the divider and is configured to be coupled to the upper collar of the blender jar. The appliance further includes a battery removably received within the battery-receiving cavity for powering the motor of the base unit.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a top perspective view of an appliance having a base unit and a jar assembly;

FIG. 2 is a cross-sectional view of the appliance of FIG. 1 taken at line II;

FIG. 3 is top perspective view of the appliance of FIG. 1 showing a battery exploded away therefrom;

FIG. 4 is a rear top perspective view of the battery of FIG. 3;

FIG. 5 is a top perspective view of the blender of FIG. 1 with the jar assembly shown removed from the base unit;

FIG. 6A is a top perspective view of a first lid assembly;

FIG. 6B is a bottom perspective view of the first lid assembly of FIG. 6A;

FIG. 6C is a bottom perspective view of the first lid assembly of FIG. 6A having a seal member exploded away therefrom;

FIG. 6D is a cross-sectional view of the first lid assembly of FIG. 6B taken at line VID;

FIG. 7 is a top perspective view of the first lid assembly exploded away from an open top of the blender jar;

FIGS. 8A-8C are front elevation views of the first lid assembly and the blender jar of FIG. 7 in various positions of engagement;

FIG. 9 is a top perspective view of an inner surface of an upper collar of the blender jar having a lock member positioned thereon;

FIG. 10 is a top perspective view of the blender jar of FIG. 1 coupled with a second lid assembly;

FIG. 11 is a bottom perspective view of the second lid assembly of FIG. 10 shown exploded away from the blender jar; and

FIG. 12 is a top perspective view of the second lid assembly of FIG. 11 showing a cap member exploded away therefrom.

The components in the figures are not necessarily to scale, emphasis instead being placed upon illustrating the principles described herein.

### DETAILED DESCRIPTION

The present illustrated embodiments reside primarily in combinations of method steps and apparatus components related to an appliance, and a user interface thereof. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

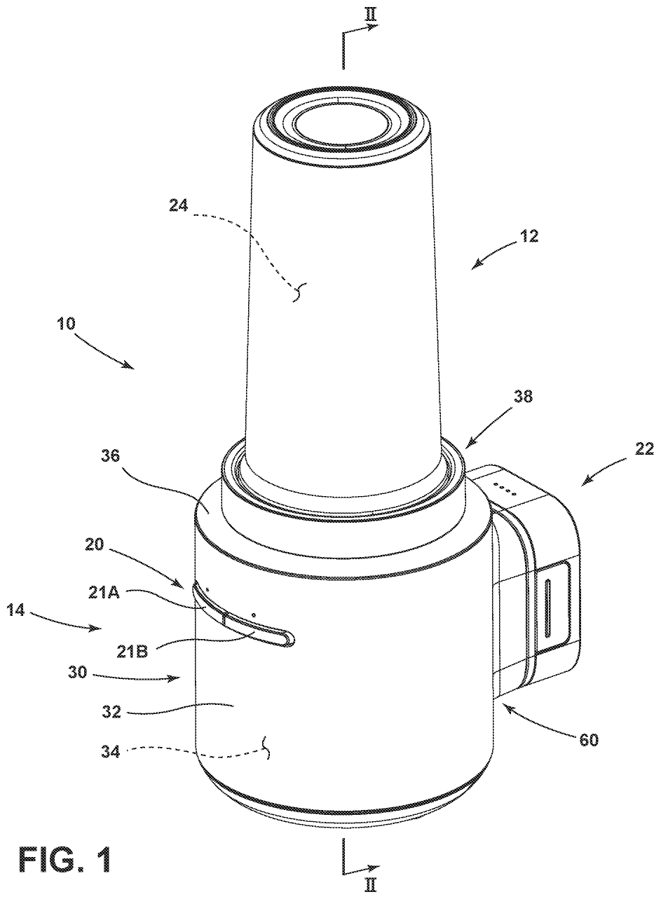

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

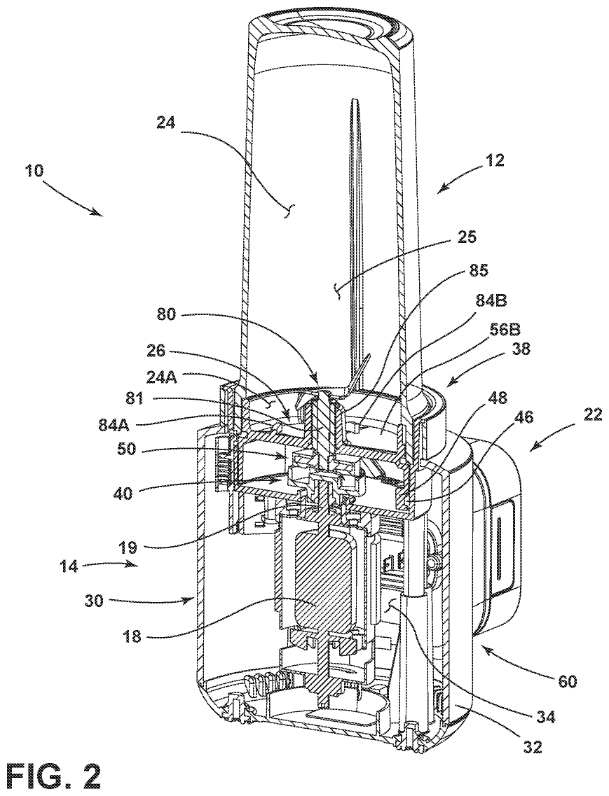

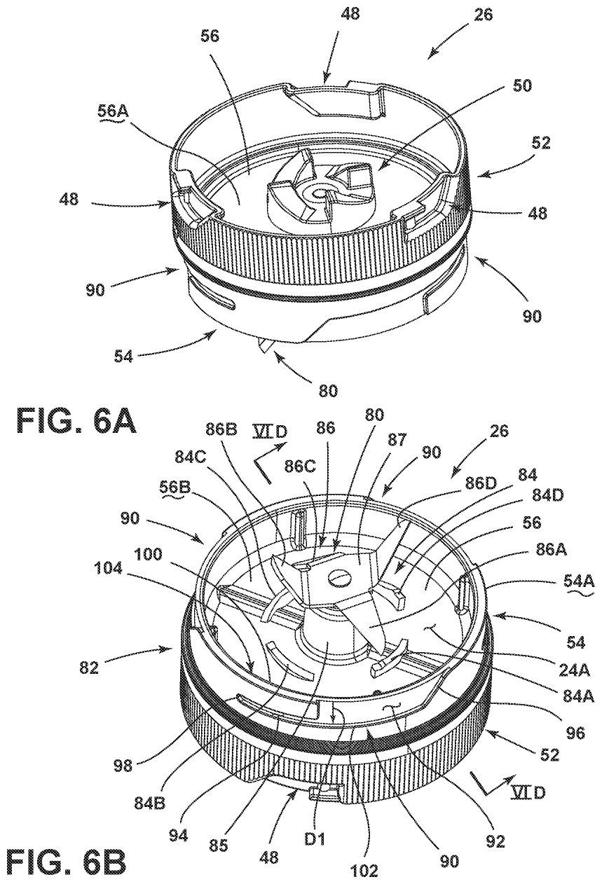

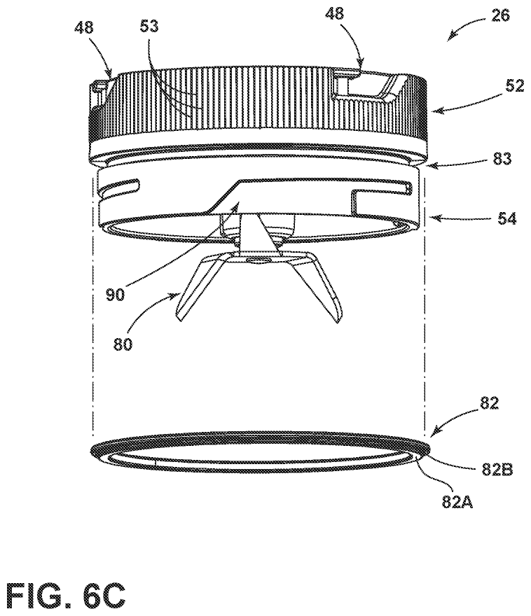

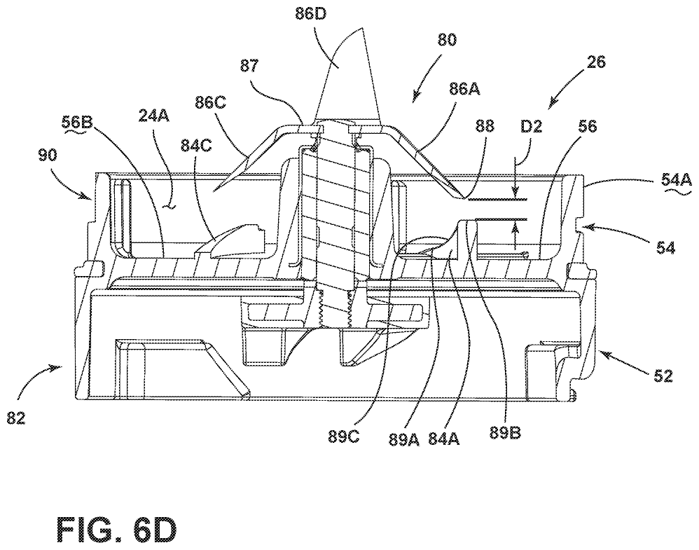

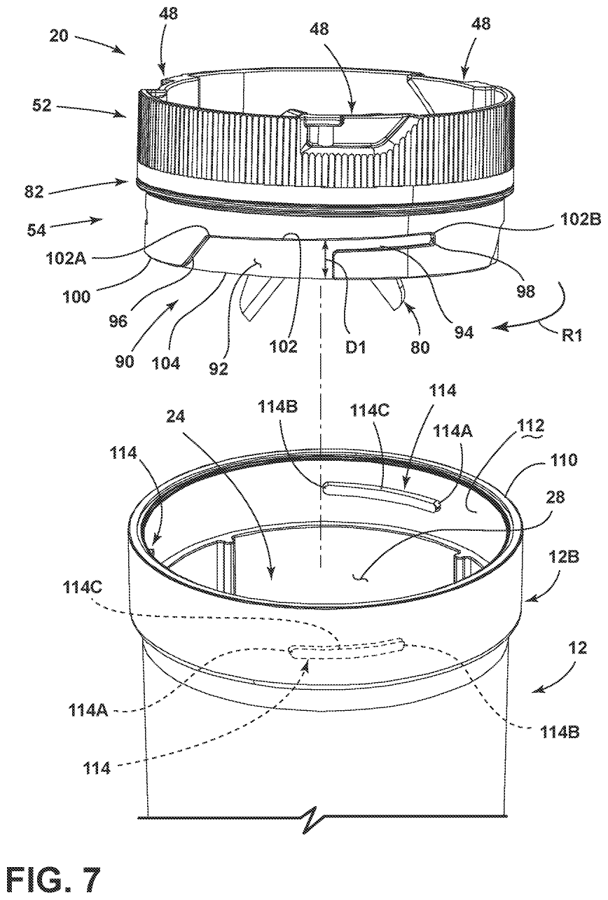

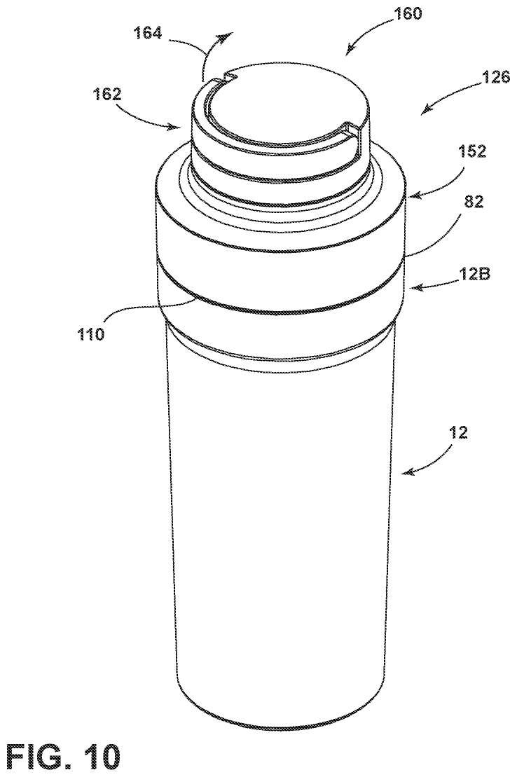

Referring now to FIG. 1, reference numeral 10 generally designates an appliance in the form of a blender. The blender 10, as shown in FIG. 1, includes a blender jar 12 that is selectively supported on a base unit 14. The blender jar 12 includes an inner cavity 24 and a first lid assembly 26 (FIGS. 6A, 6B) that is configured to couple to an open top 28 (FIG. 7) of the blender jar 12 when preparing to initiate a blending sequence. A second lid assembly 126 (FIGS. 10-12) is interchangeable with the first lid assembly 26, and provides a closed lid that is selectively accessible to the inner cavity 24 of the blender jar 12, as further described below. The base unit 14 includes a housing 30 that is generally defined by a sidewall 32 surrounding an interior cavity 34. A motor 18 (FIG. 2) is housed within the interior cavity 34 of the housing 30 of the base unit 14. In use, the motor 18 is configured to drive a blade assembly 80 (FIG. 6B) that is operably coupled to the first lid assembly 26 and positioned in communication with the inner cavity 24 of the blender jar 12, as further described below with reference to FIG. 2.

As further shown in FIG. 1, the blender 10 includes a user interface 20 positioned on the sidewall 32 of the housing 30. In the embodiment shown in FIG. 1, the user interface 20 includes buttons 21A, 21B that are contemplated to be electronically coupled to the motor 18, and configured to adjust various settings of the motor 18. The buttons 21A, 21B are contemplated to provide functional settings for the blender 10, such as blade rotational direction, speed and other like functions. It is contemplated that more or fewer buttons may be provided on the user interface 20, and other user engageable features, such as knobs, dials, rocker switches, and sliding mechanisms, may be available on the user interface 20.

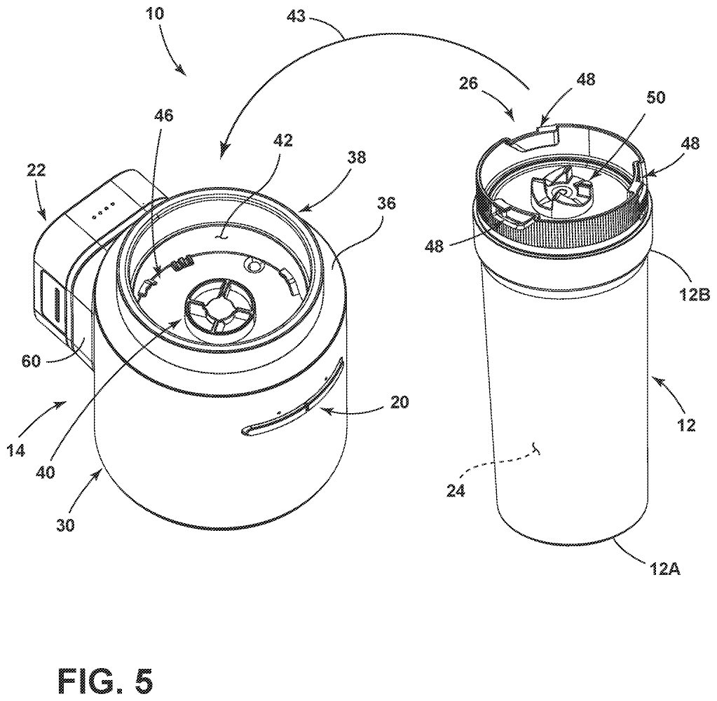

As further shown in FIG. 1, the housing 30 includes an upper surface 36. A collar 38 can be formed with or otherwise attached with the upper surface 36 of the housing 30 so as to extend upwardly from the upper surface 36 and to surround a drive connection 40 (FIGS. 2 and 5). In this manner, the collar 38 can define an upper cavity 42 of the base unit 14, within which the drive connection 40 is positioned and accessible, as further described below.

With further reference to FIG. 1, the blender 10 is contemplated to be a cordless appliance that is powered using a rechargeable power source in the form of a removable battery 22. Specifically, the housing 30 includes a collar 60 formed with or otherwise attached and outwardly extending from the sidewall 32 of the housing 30. In the embodiment shown in FIG. 1, the collar 60 is positioned on an opposite side of the housing 30 relative to the user interface 20, however, other positions for the collar 60 are also contemplated. As outwardly extending from the sidewall 32 of the housing 30, the collar 60 can define a battery-receiving cavity 62 of the base unit 14, within which the battery 22 is horizontally and removeably received in part, as further described below.

As can be appreciated, the use of the battery 22 to power the motor 18 is such that the battery-powered blender 10 described herein is operable without having to plug the blender 10 into an external power source (such as a wall outlet or the like) and results in the disclosed blender 10 being characterized as “cordless”. In this manner, the blender 10 can be placed and operated in any convenient location along the counter space provided within the kitchen, regardless of the proximity of such location to a power outlet or an available power outlet. A 20V battery and charger that can be used with the present concept is disclosed in U.S. Provisional Patent Application No. 63/315,355 titled CHARGER AND BATTERY FOR CORDLESS APPLIANCE that was filed in with the United States Patent and Trademark Office on Mar. 1, 2022 with the Atty Docket No. SUB-15280F-US-PSP, the entirety of which is incorporated herein by reference. Blender appliances having base units that can use a battery like that disclosed in U.S. Provisional Patent Application No. 63/315,355 and that can support the blender jar 12 of the present concept are disclosed in U.S. Provisional Patent Application Nos. 63/315,571 and 63/315,572 titled APPLIANCE KNOB ASSEMBLY and APPLIANCE LID ASSEMBLY, respectively, that were filed in with the United States Patent and Trademark Office on Mar. 2, 2022, the entireties of which are incorporated herein by reference.

The battery 22 and the corresponding electronic circuitry for controlling the operation of the blender 10, including the operation of the motor 18, can be configured according to an architecture using a voltage in the range of about 10-12V and in one implementation 12V, with it being understood that the actual voltage supplied and utilized may vary within a range around the described desired operating voltage according to factors generally understood in the art. In this manner, the battery 22 can be a multi-cell 12V battery, although other configurations are possible. In general, such a voltage may be sufficient for operation of the blender 10 including operation of the motor 18, which is generally understood to be a direct-current (DC) motor and in one aspect a brushless DC motor, at an acceptable torque for typically-accepted use as a food processor within an acceptable operating speed.

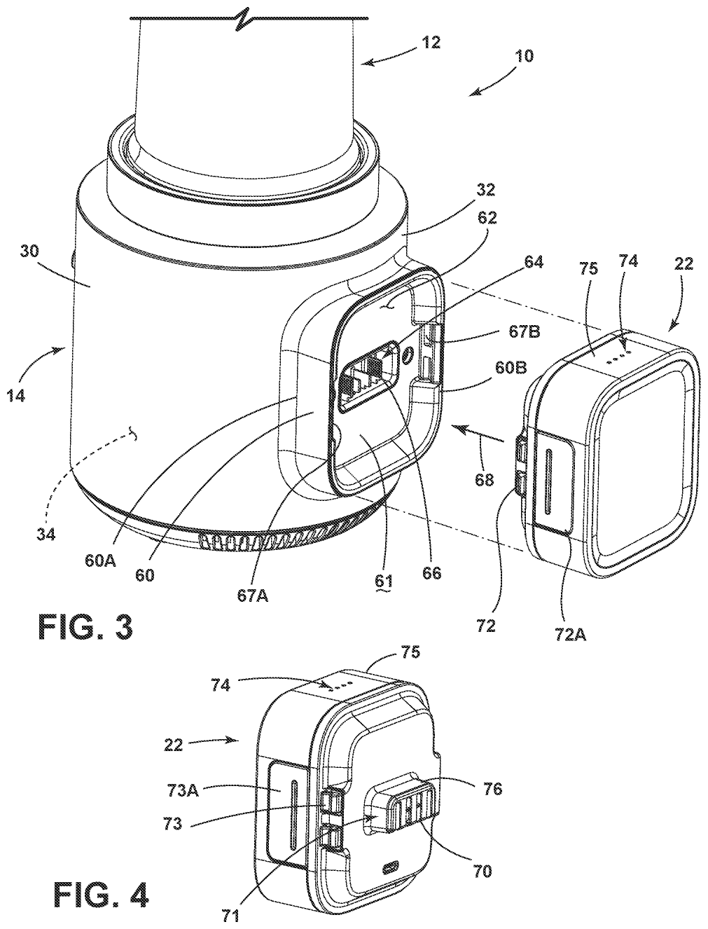

As discussed above, the blender 10 is configured to operate under the power of a generally smaller battery 22 than the 20V version of the battery disclosed in the provisional applications cited above. In this respect, the battery 22 may be smaller in output, such as by being configured for 12V operation. Additionally, because a smaller output battery 22 provides a lower current to the associated device, the battery 22 can also be smaller in size, while still providing the desired duration of power supply and corresponding use of the blender 10 (or other related appliance). The releasable connection between the battery 22 and the base unit 14 of the blender 10 is further described below with specific reference to FIGS. 3 and 4.

Referring now to FIG. 2, the motor 18 is shown disposed within an interior cavity 34 of the housing 30 of the base unit 14. As noted above, the motor 18 is configured to drive the blade assembly 80 that is shown in FIG. 2 as being operably coupled to the first lid assembly 26 and positioned in communication with the inner cavity 24 of the blender jar 12. In FIG. 2, a driveshaft 19 is shown as being operably coupled between the motor 18 and the drive connection 40 of the base unit 14. In this way, the motor 18 powers rotation of the drive connection 40 within the upper cavity 42 of the base unit 14. Further, a drive connecting member 50 is provided on the first lid assembly 26 and operably coupled to the blade assembly 80 by an interconnecting shaft 81. Thus, the motor 18 is configured to power rotation of the drive connection 40 via the driveshaft 19. The drive connection 40 is configured to drive rotation of the drive connecting member 50 as operably coupled thereto when the blender jar 12 is inverted and supported on the base unit 14 for a blending sequence. Rotation of the drive connecting member 50 drives rotation of the blade assembly 80 via interconnecting shaft 81. In this way, the motor 18 is configured to drive rotation of the blade assembly 80 within the inner cavity 24 of the blender jar 12 for blending contents of the blender jar 12.

Referring now to FIG. 3, the battery 22 is shown removed from the battery-receiving cavity 62. As noted above, the battery 22 is contemplated to be coupled with the housing 30 of the base unit 14 in a removable manner within the depicted battery-receiving cavity 62. In this way, a selected battery of any number of available compatible batteries can be selected and attached to the blender 10 for powering the operation of the blender 10. As shown in FIG. 3, the battery-receiving cavity 62 includes an outer surface 61 from which the collar 60 outwardly extends to surround the battery-receiving cavity 62. The battery-receiving cavity 62 further includes a number of terminals 64 that are positioned within a terminal receptacle 66 that inwardly extends towards the interior cavity 34 of the base unit 14.

As further shown in FIG. 3, the battery 22 is adapted for a snap-fit arrangement with the battery-receiving cavity 62, wherein the battery 22 is moved in a lateral direction 68 toward the battery-receiving cavity 62 and pressed into horizontal engagement therewith. In this arrangement, the terminals 64 of the battery-receiving cavity 62 engage with aligned battery terminals 70 (FIG. 4) of the battery 22 for electrical connection with the battery 22 when fully received in the battery-receiving cavity 62. As shown in FIGS. 3 and 4, the battery 22 can include spring-loaded tabs 72, 73 disposed on opposite sides of the battery 22 that are urged outwardly in a spring-loaded manner, such that they can be moved inwardly by initial engagement with corresponding notches 67A, 67B which are disposed on opposite sides 60A, 60B of the collar 60. Thus, the collar 60 includes the notches 67A, 67B which inwardly extend into the opposite sides 60A, 60B of the collar 60 within the battery-receiving cavity 62. As the battery 22 is brought into contact with the collar 60 positioned in front of the notches 67A, 67B, the tabs 72, 73 move inwardly until they pass the collar 60 and are aligned with the notches 67A, 67B. As outwardly biased, the tabs 72, 73 move into reception with the notches 67A, 67B, respectively, when so aligned. In this way, the battery 22 is fully received in the battery-receiving cavity 62 for fixed retention therewith. When the battery 22 is to be removed, buttons 72A, 73A associated with the tabs 72, 73, respectively can be depressed to move the tabs 72, 73 inward, thereby releasing them from the respective notches 67A, 67B. In this manner, the battery 22 can be removed from the blender 10 for use with another compatible kitchen appliance (such as a hand mixer, a hand blender, a food processor, or another countertop blender) or to be replaced with a charged battery, such as when the battery 22 has become depleted. In this manner, a depleted battery can be charged using a compatible charger having mechanical components similar to the battery-receiving cavity 62 and terminals 64 shown in connection with the present blender 10.

With specific reference to FIG. 4, the battery 22 includes a plug 71 in which the terminals 70 thereof are positioned. The plug 71 of the battery 22 outwardly extends from a rear surface 76 of the battery 22 and is configured to be received in the receptacle 66 of the battery-receiving cavity 62, when the battery 22 is fully engaged with the battery-receiving cavity 62. In this way, an electrical connection is facilitated by connection of the terminals 70 of the battery 22 with the terminals 64 of the blender 10 that are exposed within the battery-receiving cavity 62 for powering the motor 18 of the blender 10.

Referring now to FIG. 5, the collar 38 of the base unit 14 is shown upwardly extending from the upper surface 36 of the housing 30 to surround the drive connection 40. As noted above, the collar 38 defines a portion of the upper cavity 42 of the base unit 14, such that the upper cavity 42 of the base unit 14 is an upwardly opening upper cavity. With the blender jar 12 removed from the base unit 14, the drive connection 40 is shown as positioned within the upper cavity 42 of the base unit 14 and is visible and accessible therefrom. The drive connection 40 is disposed on a bottom wall In FIG. 5, the blender jar 12 has been removed from the base unit 14 and positioned in an upright position, wherein the blender jar 12 is supported on a support surface at a lower portion 12A thereof. The first lid assembly 26 is shown positioned on an upper collar 12B of the blender jar 12. The first lid assembly 26 is configured to engage the upper collar 12B of the blender jar 12 in a locking engagement, as further described below. For reception of the blender jar 12 on the base unit 14, the blender jar 12 is inverted and vertically received on the base unit 14 along the path as indicated by arrow 43. Movement of the blender jar 12 along the path as indicated by arrow 43 provides for the reception of the first lid assembly 26 within the upper cavity 42 defined by the collar 38 of the base unit 14. As shown in FIG. 5, the first lid assembly 26 and the upper cavity 42 are both generally circular in shape, such that the first lid assembly 26 can fit within the collar 38 in generally close contact therewith, as shown in FIGS. 1 and 2. With the first lid assembly 26 positioned within the upper cavity 42 of the base unit 14, drive connection 40 is coupled to or otherwise engaged with the drive connecting member 50 of the first lid assembly 26, as best shown in FIG. 2.

As further shown in FIG. 5, a plurality of alignment tabs 46 are positioned in the upper cavity 42 around the drive connection 40. The first lid assembly 26 can, accordingly, define a plurality of connecting members 48 corresponding with respective ones of the plurality of alignment tabs 46 for receipt thereof into the connecting members 48 when the blender jar 12 is mounted on the base unit 14, as best shown in FIG. 2. As such, the upper cavity 42 of the base unit 14 includes the alignment tabs 46 provided therein to releasably receive the connecting members 48 to secure the blender jar 12 to the base unit 14. This arrangement helps to prevent rotation of the blender jar 12 relative to the base unit 14, including under torque of the motor 18. As shown in FIG. 5, the collar 38 can be inset relative to an outer edge of the upper surface 36 to, in one aspect, allow for the desired fitting of the blender jar 12 to the base unit 14, while facilitating a base unit 14 arrangement with a generally wider footprint for increased stability.

Referring now to FIGS. 6A and 6B, the first lid assembly 26 is shown from top and bottom perspective views, respectively. In the top view of FIG. 6A, the first lid assembly 26 is shown to include a first collar 52 and a second collar 54 that are separated by a divider 56, such that the first and second collars 52, 54 are disposed on opposite sides of the divider 56. A first surface 56A of the divider 56 of the first lid assembly 26 includes the drive connecting member 50 which freely rotates within the parameters of the first collar 52. As noted above, the drive connecting member 50 is configured to couple to the drive connection 40 of the base unit 14 when the first lid assembly 26 is positioned within the upper cavity 42 of the base unit 14, as best shown in FIG. 2. The connecting members 48 of the first lid assembly 26 are shown disposed around the first collar 52 along an outer surface thereof. In the embodiment shown in FIG. 6A, the first lid assembly 26 includes three connecting members 48 which are contemplated to correspond to three alignment tabs 46 positioned in the upper cavity 42 of the housing 30 of the base unit 14 to provide a twist-lock mechanism for engaging the blender jar 12 with the base unit 14. In the bottom view of FIG. 6B, the first lid assembly 26 is shown to include the blade assembly 80 extending outwardly from a second surface 56B of the divider 56. As noted above, the blade assembly 80 is configured to blend ingredients disposed within the inner cavity 24 of the blender jar 12 when the blender jar 12 and the first lid assembly 26 are supported on the base unit 14 for a blending sequence. In the bottom view of FIG. 6B, a seal member 82 is shown positioned between the first and second collars 52, 54 of the first lid assembly 26, as further described below.

As further shown in FIG. 6B, the second collar 54 of the first lid assembly 26 includes a number of engagement channels 90 that define outwardly open channels that are recessed into the second collar 54 along an outer surface 54A thereof. In this way, the engagement channels 90 are disposed around the second collar 54 at the outer surface 54A thereof for engaging the upper collar 12B of the blender jar 12, as further described below. Each engagement channel 90 includes a first portion 92 and a second portion 94. Each first portion 92 includes an introductory ramp 96 which is an angled member directed from a rim portion 100 of the second collar 54 of the first lid assembly 26 towards the second portion 94 of the engagement channels 90. The introductory ramp 96 facilitates the introduction of a lock member 114 (FIG. 7) disposed on the upper collar 12B of the blender jar 12 into the first portion 92 of a corresponding engagement channel 90, as further described below. Each second portion 94 of the engagement channels 90 includes an end wall 98. As shown in the embodiment of FIG. 6B, the engagement channel 90 illustrated therein shows that the first portion 92 thereof is a wider portion as compared to the second portion 94. Specifically, the first portion 92 of the engagement channel 90 shown in FIG. 6B extends into an opening 104 into the engagement channel 90, positioned at the rim portion 100 of the second collar 54 of the first lid assembly 26, towards an upper wall 102 of the engagement channel 90 at a length D1. The length D1 provided from the opening 104 of the engagement channel 90 is contemplated to be a sufficient length to ensure engagement between an upper rim 110 (FIG. 7) of the blender jar 12 and the seal member 82 of the first lid assembly 26, as further described below. Together, the second collar 54 and the divider 56 define a cavity 24A. The cavity 24A of the first lid assembly 26 and the inner cavity 24 of the blender jar 12 cooperate to define an overall blending cavity 25 (FIG. 2), where ingredients are mixed by the blade assembly 80 when the first lid assembly 26 is received on the blender jar 12, and the blender jar 12 is received on the base unit 14.

As further shown in FIG. 6B, the blade assembly 80 includes a plurality of blades 86 that is comprised of blades 86A-86D. Specifically, the blades 86A-86D of the plurality of blades 86 extends outwardly from a baseplate 87, with blades 86A, 86C extending downwardly from the baseplate 87, and blades 86B, 86D extending upwardly from the baseplate 87. Thus, the blades 86A and 86C are contemplated to at least partially rotate within the cavity 24A defined by the first lid assembly 26, while blades 86B and 86D are contemplated to rotate within the inner cavity 24 of the blender jar 12. Said differently, blades 86A and 86C extend towards the second surface 56B of the divider 56 of the first lid assembly. With the configuration of the blades 86A-86D, the blades 86A-86D are configured to provide a vortex within the overall blending cavity 25. The first lid assembly 26 further includes an inner collar 85 extending outwardly from the second surface 56B of the divider 56. The inner collar 85 of the first lid assembly 26 houses the interconnecting shaft 81 which is coupled to the blade assembly 80, as best shown in FIG. 2. As further shown in FIG. 6B, a plurality of ramps 84 outwardly extend from the second surface 56B of the divider 56 of the first lid assembly 26. The plurality of ramps 84 is comprised of ramps 84A-84D which are disposed in a general ring configuration around the inner collar 85. The plurality of ramps 84 helps to mix ingredients by facilitating introduction of ingredients to the blade assembly 80, as further described below.

Referring now to FIG. 6C, the seal member 82 of the first lid assembly 26 is shown exploded away therefrom. With the seal member 82 exploded away from the first lid assembly 26, a receiving channel 83 is shown disposed between the first and second collars 52, 54 of the first lid assembly 26. The receiving channel 83 is an inset channel that is contemplated to be circumferentially disposed around the second collar 54 at an upper portion thereof. As further shown in FIG. 6C, the seal member 82 is a ring seal having an inset portion 82A and an outer portion 82B that are provided in a stepped configuration relative to one another. In assembly, the inset portion 82A of the seal member 82 is contemplated to be received within the receiving channel 83 of the first lid assembly 26, such that the outer portion 82B outwardly extends from the receiving channel 83 of the first lid assembly 26 for engagement with the upper rim 110 of the blender jar 12, as further described below. As further shown in FIG. 6C, the first collar 52 of the first lid assembly 26 includes a plurality of ribs 53 vertically positioned therearound. In use, the ribs 53 of the first collar 52 of the first lid assembly 26 are provided to help a user grip and engage the first lid assembly 26 for rotational locking movement thereof.

Referring now to FIG. 6D, the first lid assembly 26 is shown from a cross-sectional view. In the view provided in FIG. 6D, the blade 86A of the blade assembly 80 is shown having a distal end 88. Ramp 84A of the plurality of ramps 84 is shown disposed directly under the distal end 88 of the blade 86A. Blade 86C also includes a distal end that is akin to the distal end 88 of blade 86A. Further, the ramp 84A includes a first end 89A and a second end 89B. The first end 89A may be referred to herein as the lower end of the ramp 84A, while the second end 89B may be referred to herein as the upper end of the ramp 84A. The ramp 84 further includes an upper surface 89C that extends between the first end 89A and the second end 89B. As configured in a wedge configuration, the upper surface 89C of the ramp 84A is and upwardly angled surface extending from the first end 89A to the second end 89B in a curved configuration. The configuration described herein of ramp 84A also describes the configuration of ramps 84B-84D. As noted above, the ramps 84A-84D are each provided in a curved configuration so that the plurality of ramps 84 is provided in a ring configuration that is aligned with the rotational path of the blades 86A, 86C as measured from the distal ends 88 thereof. In this way, a distance D2 is provided between the distal end 88 of the blade 86A and of the second end 89B of ramp 84A. The distance D2 defines a pinch point between the distal end 88 of the blade 86A and the second end 89B of the ramps 84A-84D as blade 86A rotates along the rotational path, where ingredients are directed towards the blade assembly 80 for mixing within the overall blending cavity 25. Similarly, blade 86C also defines a similar pinch point between the second ends 89B of the ramps 84A-84D as it rotates along its rotational path. Thus, the blades 86A-86D and the ramps 84A-84D cooperate to create and sustain the vortex of ingredients in a blending procedure.

Referring now to FIG. 7, the first lid assembly 26 is shown exploded away from the upper collar 12B of the blender jar 12. The upper collar 12B of the blender jar 12 includes the upper rim 110 surrounding the open top 28 of the blender jar 12. Along an inner surface 112 of the upper collar 12B, a number of lock members 114 extend inwardly into the inner cavity 24 of the blender jar 12. As a first lid assembly 26 is received on the upper collar 12B of the blender jar 12, the second collar 54 of the first lid assembly 26 will align with the upper collar 12B of the blender jar 12. Corresponding engagement channels 90 positioned on the second collar 54 of the first lid assembly 26 will align with the lock members 114 of the blender jar 12. As the first lid assembly 26 is moved downward onto the upper collar 12B of the blender jar 12, the lock members 114 will be received within the first portion 92 of the engagement channels 90. Reception of the lock members 114 within the first portion 92 of the engagement channels 90 may be aided by the introductory ramp 96 acting on a first end 114A of the lock members 114. As specifically shown in FIG. 7, the visible engagement channel 90 is aligned to engage with the lock member 114 shown in phantom on the blender jar 12. The introductory ramp 96 may act on the first end 114A of the lock member 114 to urge the lock member 114 into the first portion 92 of the engagement channel 90. With the lock member 114 aligned with the opening 104 of the engagement channel 90, the first lid assembly 26 will drop down the length D1 identified between the upper wall 102 of the engagement channel 90 and the rim portion 100 of the second collar 54. With the first lid assembly 26 in this dropped-down position, is contemplated that an upper edge 114C of the lock member 114 may abut upper wall 102 of the engagement channel 90 at a first end 102A thereof, when the lock member 114 is fully received within the first portion 92 of the engagement channel 90. Further, with the first lid assembly 26 in the dropped-down position, is contemplated that the upper rim 110 of the blender jar 12 may abut the seal member 82 of the first lid assembly 26.

As further shown in FIG. 7, the upper wall 102 of the engagement channel 90 includes the first end 102A disposed at the first portion 92 of the engagement channel 90, and a second end 102B disposed at the second portion 94 of the engagement channel 90. The upper wall 102 of the engagement channel 90 is an angled wall that upwardly ascends from the first end 102A to the second end 102B thereof. In this way, when the first lid assembly 26 is in the dropped-down position and the lock member 114 is fully received within the first portion 92 of the engagement channel 90, the first lid assembly 26 can be rotated in the locking rotational direction as indicated by arrow R1 (FIG. 7). This rotational movement of the second lid assembly in the direction as indicated by arrow R1 moves the lock member 114 from the first portion 92 of the engagement channel 90 to the second portion 94 of the engagement channel 90. As the lock member 114 moves along the upper wall 102 of the engagement channel 90, the first lid assembly 26 will be drawn down towards the open top 28 of the blender jar 12 to thereby compress the seal member 82 against the upper rim 110 of the blender jar 12, as shown in FIG. 5. It is contemplated that the engagement between the engagement channels 90 of the first lid assembly 26 and the lock members 114 of the blender jar 12 firmly positions the first lid assembly 26 on the blender jar 12 in a sufficient manner for a blending sequence.

As noted above, the first lid assembly 26 moves to a dropped-down position as the lock member 114 enters the first portion 92 of the engagement channel 90. This vertical drop down movement provided along the length D1 of the engagement channel 90 allows for the first lid assembly 26 to forgo a series of full rotations that would otherwise be necessary in a standard threaded engagement. Instead, the first lid assembly 26 of the present concept is contemplated to rotate approximately only 90° or less to sufficiently engage the first lid assembly 26 with the upper collar 12B of the blender jar 12. It is further contemplated that the first lid assembly 26 of the present concept could rotate less than 45° to sufficiently engage the first lid assembly 26 with the upper collar 12B of the blender jar 12. The locking rotational movement of the first lid assembly 26 along the path as indicated by arrow R1 is generally limited to the movement of the engagement channel 90 relative to the blender jar 12 in such a manner that the lock member 114 of the blender jar 12 moves from the first portion 92 to the second portion 94 of the engagement channel 90. As noted above, it is contemplated that a plurality of lock members 114 and a plurality of engagement channels 90 are provided on the blender jar 12 and the first lid assembly 26, respectively, for full engagement of the first lid assembly 26 with the blender jar 12.

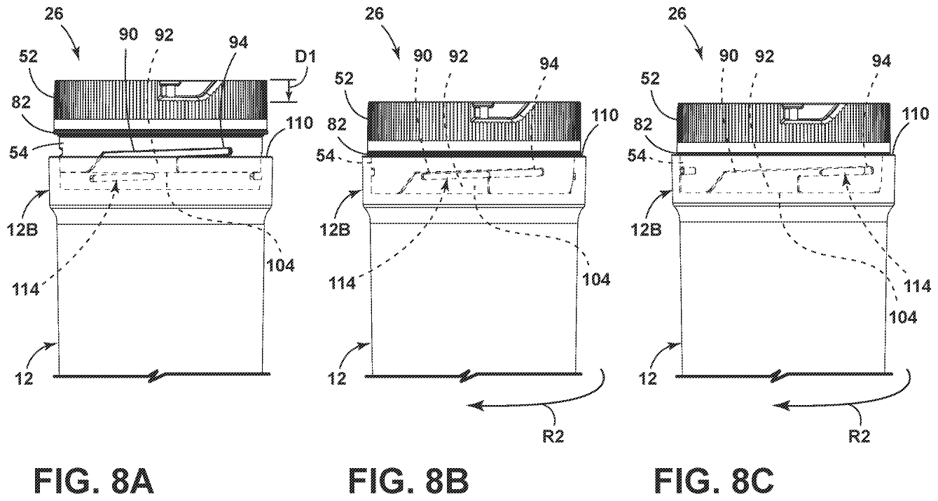

Referring now to FIGS. 8A-8C, the improved efficiency of the interconnection between the first lid assembly 26 and the blender jar 12 is illustrated. With specific reference to FIG. 8A, the first lid assembly 26 is shown in a first position. In the first position of FIG. 8A, the second collar 54 of first lid assembly 26 has partially entered into the inner cavity 24 of the blender jar 12. It is contemplated that with the first lid assembly 26 in the first position, the lock members 114 of the upper collar 12B of the blender jar 12 are aligned with the openings 104 of the respective engagement channels 90, as shown in phantom in FIG. 8A. With specific reference to FIG. 8B, the first lid assembly 26 is shown in a second position. In the second position of FIG. 8B, the lock members 114 of the upper collar 12B of the blender jar 12 are contemplated to be received within the first portions 92 of the respective engagement channels 90, as shown in phantom in FIG. 8B. As further shown in FIG. 8B, the seal member 82 of the first lid assembly 26 abuts the upper rim 110 of the blender jar 12. The second position of the first lid assembly 26 is discussed above as the dropped-down position. Thus, movement from the first position to the second position is a vertical movement that may bring the seal member 82 of the first lid assembly 26 into engagement with the upper rim 110 of the blender jar 12. With specific reference to FIG. 8C, the first lid assembly 26 is shown in a third position. In the third position of FIG. 8C, the lock members 114 of the upper collar 12B of the blender jar 12 are contemplated to be received within the second portions 94 of the respective engagement channels 90, as shown in phantom in FIG. 8C. Movement of the lock members 114 from the first portions 92 of the respective engagement channels 90 to the second portions 94 of the respective engagement channels 90 involves a rotational movement of the blender jar 12, or the first lid assembly 26. Moving from FIG. 8B to FIG. 8C, it is contemplated that the blender jar 12 has moved in the rotational direction as indicated by arrow R2 relative to the first lid assembly 26 to move the lock members 114 of the upper collar 12B of the blender jar 12 to the fully engaged positions, wherein the lock members 114 are positioned within the second portions 94 of the engagement channels 90. As noted above, the upper walls 102 of the engagement channels 90 are inclined from the first ends 102A thereof to the second ends 102B thereof. In this way, the movement of the locking members 114 from the first portions 92 of the engagement channels 90 to the second portions 94 of the engagement channels 90 draws the first lid assembly 26 downward for full engagement between the seal member 82 and the upper rim 110 of the blender jar 12, as shown in FIG. 8C.

As noted above, the vertical movement of the first lid assembly 26 from the dropped-down (or second position)(FIG. 8B) to the third position (FIG. 8C) may involve only 45° rotation or less of the blender jar 12 for the first lid assembly 26, relative to one another. This makes for a system wherein the first lid assembly 26 can be quickly positioned in a secure position for a blending sequence. It is further contemplated that a threaded collar assembly of a blender jar 12 which may be used, wherein multiple 360° rotations of a lid assembly 26 are provided to fully engage the threaded collar assembly of the blender jar 12.

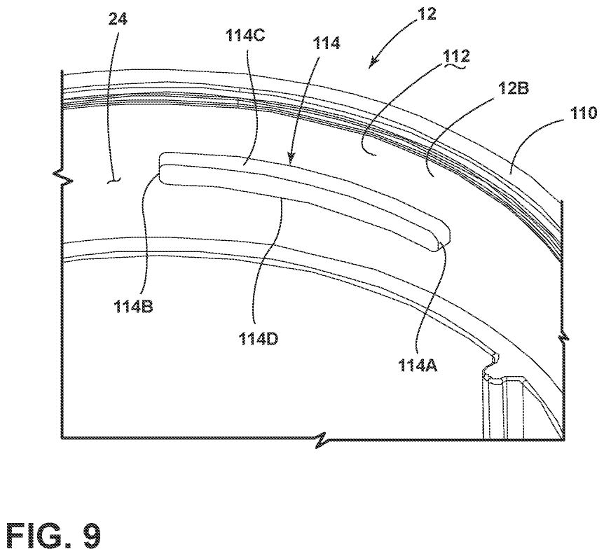

Referring now to FIG. 9, a lock member 114 is shown disposed along the inner surface 112 of the upper collar 12B of the blender jar 12. As noted above, the lock member 114 includes first and second ends 114A, 114B, as well as upper and lower edges 114C, 114D. In the embodiment shown in FIG. 9, the lock member 114 is provided at an angle along the inner surface 112 of the upper collar 12B. Specifically, the lock member 114 sends vertically from the first end 114A to the second end 114B. In this way, the upper and lower edges 114C, 114D of the lock member 114 can act on the perimeter edges of the second portion 94 of a corresponding engagement channel 90 to further draw down the first lid assembly 26 into engagement with the blender jar 12 during a rotational movement thereof. It is contemplated that the locking members 114 may be positioned at an angle of approximately 1° to 5° along the inner surface 112 of the upper collar 12B of the blender jar 12, and preferably at an angle of 2°.

Referring now to FIG. 10, a second lid assembly 126 is shown coupled to the blender jar 12 at the upper collar 12B thereof. The second lid assembly 126 is contemplated to be interchangeable with the first lid assembly 26 with regards to engagement of the upper collar 12B of the blender jar 12. As noted above, the first lid assembly 26 is provided for coupling with the blender jar 12 for a blending sequence using the blade assembly 80 of the first lid assembly 26. The second lid assembly 126 is provided as a cover for the open top 28 of the blender jar 12, such that a user can use the blender jar 12 as a drink receptacle. The second lid assembly 126 includes a number of features that are similar or the same as the first lid assembly 26, for which like reference numerals are provided for the description herein.

As further shown in FIG. 10, the second lid assembly 126 includes a cap member 160 that is contemplated to be a removable cap member for providing access to the inner cavity 24 of the blender jar 12. The cap member 160 includes a handle 162 that is pivotally coupled to the cap member 160 for deployment in the direction as indicated by arrow 164 to a deployed position from a stowed position. In FIG. 10, the handle 162 is illustrated as a curved member provided in the stowed position. In the deployed position, the handle 162 of the second lid assembly 126 can be grasped by a user to carry the blender jar 12.

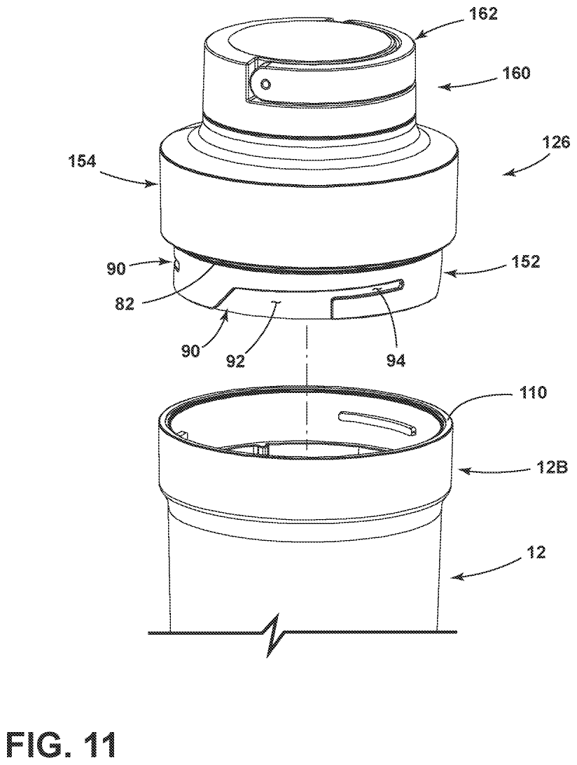

Referring now to FIG. 11, the second lid assembly 126 includes an upper collar 154 and a lower collar 152 with a seal member 82 disposed therebetween. The seal member 82 engages the upper rim 110 of the blender jar 12 in an engaged position, as shown in FIG. 10. As further shown in FIG. 11, the second lid assembly 126 includes a plurality of engagement channels 90 disposed on the lower collar 152 thereof. The engagement channels 90 of the second lid assembly 126 include the same structural features as the engagement channels 90 discussed above with reference to the first lid assembly 26. Thus, the second lid assembly 126 is capable of quick engagement with the upper collar 12B of the blender jar 12 at the locking members 114 thereof using the engagement channels 90 in a manner as described above with reference to the first lid assembly 26. In this way, a user can interchange the first lid assembly 26 after a blending sequence with the second lid assembly 126 to thereby use the blender jar 12 is a portable beverage receptacle. Using the efficient interlocking features of the first lid assembly 26 and the second lid assembly 126, a user is not subjected to full rotations of either lid assembly as is generally the case in a fully threaded lid assembly-to-blender jar configuration.

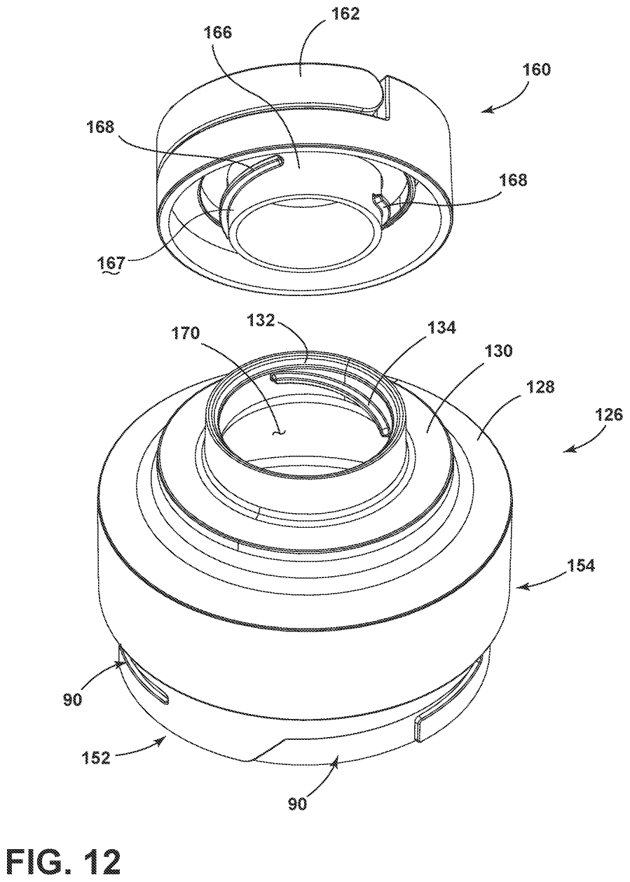

Referring now to FIG. 12, the second lid assembly 126 is shown with the cap member 160 exploded away therefrom. With the cap member 160 exploded away from the second lid assembly 126, a centrally disposed open aperture 170 of the second lid assembly 126 is revealed. Specifically, the upper collar 154 of the second lid assembly 126 includes a ring portion 128 that is substantially planar. A stem portion 130 extends upwardly from the ring portion 128 and includes an inner surface 132 having a plurality of threaded members 134 disposed thereon. Specifically, the stem portion 130 surrounds the open aperture 170, such that the threaded members 134 thereof inwardly extend into the open aperture 170. As further shown in FIG. 12, the cap member 160 includes a downwardly extending stem portion 166 having a plurality of threaded members 168 which outwardly extend from an outer surface 167 of the downwardly extending stem portion 166. As shown in FIG. 12, the downwardly extending stem portion 166 of the cap member 160 is an inset member relative to an outer surface of the cap member 160. The threaded members 168 of the downwardly extending stem portion 166 of the cap member 160 are contemplated to be reciprocal or complementary thread members to the threaded members 134 positioned on the stem portion 130 around the open aperture 170 of the second lid assembly 126. In this way, the cap member 160 can be threadingly engaged with the second lid assembly 126 to selectively provide access to the open aperture 170. With the second lid assembly 126 positioned on the upper collar 12B of the blender jar 12, the open aperture 170 of the second lid assembly 126 is positioned in fluid communication with the inner cavity 24 of the blender jar 12.

According to one aspect of the present disclosure, a cordless appliance includes a blender having a base unit with a housing and an upwardly opening upper cavity. A drive connection is positioned within the upwardly opening upper cavity. The housing further includes a battery-receiving cavity that is configured to receive a removable battery. A motor is disposed within the housing of the base unit it is contemplated to be powered by the removable battery. A blender jar includes an upper collar in an interior cavity. A first lid assembly is configured to be coupled to the upper collar of the blender jar and includes a blade assembly and a drive connecting member. A second lid assembly includes a cap member removably received on an open aperture of the second lid assembly. The first and second lid assemblies are configured for limited rotation with respect to the blender jar for engagement of the same.

According to one aspect of the present disclosure, an appliance includes a base unit having a housing with an upwardly opening upper cavity with a drive connection positioned therein. The housing further includes a battery-receiving cavity. A motor is disposed within the housing of the base unit. A blender jar includes an upper collar and an interior cavity. A first lid assembly removeably couples to the upper collar of the blender jar and the upwardly opening upper cavity of the base unit. The first lid assembly includes a drive connecting member disposed on a first side thereof and a blade assembly disposed on a second side thereof. The drive connecting member engages the drive connection of the base unit when the first lid assembly is coupled to the upwardly opening upper cavity of the base unit. A battery is removably received within the battery-receiving cavity for powering the motor of the base unit.

According to another aspect, the battery is a 12V battery.

According to another aspect, the appliance includes a second lid assembly contemplated to be interchangeable with the first lid assembly. The second lid assembly is configured to be coupled to the upper collar of the blender jar. The second lid assembly includes a cap member removably received on an open aperture of the second lid assembly.

According to another aspect, the second lid assembly includes a handle disposed thereon.

According to another aspect, the handle is disposed on the cap member of the second lid assembly.

According to another aspect, the handle is operable between deployed and stowed positions on the cap member.

According to another aspect, the upper collar of the blender jar includes one or more locking members inwardly extending from an inner surface thereof.

According to another aspect, the first lid assembly and the second lid assembly each include one or more engagement channels in which the locking members of the blender jar are received with a 45° or less rotation thereof.

According to another aspect of the present disclosure, an appliance includes a base unit having a housing with an upwardly opening upper cavity with a drive connection positioned therein. The housing further includes a battery-receiving cavity. A motor is disposed within the housing of the base unit. A blender jar includes an upper collar and an interior cavity. A lid assembly includes first and second collars disposed on opposite sides of a divider. The first collar surrounds a drive connecting member positioned on a first side of the divider and is removeably coupled to the upper cavity of the base unit. The second collar surrounds a blade assembly on a second side of the divider and is removeably coupled to the upper collar of the blender jar. The drive connecting member engages the drive connection of the base unit when the lid assembly is coupled to the upwardly opening upper cavity of the base unit at the first collar thereof. The appliance further includes a battery removably received within the battery-receiving cavity for powering the motor of the base unit.

According to another aspect, the first collar includes at least one connecting member provided on an outer surface thereof.

According to another aspect, the upper cavity of the base unit includes at least one alignment tab provided therein to releasably receive the at least one connecting member.

According to another aspect, the second side of the divider includes a plurality of ramps outwardly extending therefrom. Each ramp includes an angled upper surface that is disposed in a curved configuration.

According to another aspect, the blade assembly includes a plurality of blades outwardly extending from a baseplate. One or more blades of the plurality of blades includes a distal end that extends towards the second side of the divider for rotation along a rotational path.

According to another aspect, each ramp of the plurality of ramps is disposed in a curved configuration that is aligned with the rotational path.

According to another aspect, the battery is a 12V battery.

According to still another aspect of the present disclosure, an appliance includes a base unit having a housing with an upwardly opening upper cavity with a drive connection positioned therein. The housing further includes a battery-receiving cavity. A motor is disposed within the housing of the base unit. A blender jar includes an upper collar and an interior cavity. A lid assembly includes first and second collars disposed on opposite sides of a divider. The first collar surrounds a drive connecting member positioned on a first side of the divider and is configured to be coupled to the upper cavity of the base unit. The second collar surrounds a blade assembly on a second side of the divider and is configured to be coupled to the upper collar of the blender jar. The appliance further includes a battery removably received within the battery-receiving cavity for powering the motor of the base unit.

According to another aspect, the base unit includes a sidewall surrounding an interior cavity. The sidewall includes a collar outwardly extending therefrom. The collar surrounds the battery-receiving cavity.

According to another aspect, the collar of the base unit includes notches disposed on opposite sides thereof. The battery includes tabs that engage the notches of the collar when the battery is received in the battery-receiving cavity.

According to another aspect, the battery-receiving cavity includes a number of terminals that are positioned within a terminal receptacle that inwardly extends towards the interior cavity of the base unit.

According to another aspect, the battery is a 12V battery. The battery includes a plug that outwardly extends from a rear surface of the battery. The plug is removeably received in the receptacle of the battery-receiving cavity.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. An appliance, comprising:
a base unit having a housing with an upwardly opening upper cavity with a drive connection positioned therein, wherein the housing further includes a battery-receiving cavity;
a motor disposed within the housing of the base unit;
a blender jar having an upper collar and an interior cavity;
a first lid assembly removeably coupled to the upper collar of the blender jar and the upwardly opening upper cavity of the base unit, wherein the first lid assembly includes a drive connecting member disposed on a first side thereof, and a blade assembly disposed on a second side thereof, and further wherein the drive connecting member engages the drive connection of the base unit when the first lid assembly is coupled to the upwardly opening upper cavity of the base unit; and
a battery removably received within the battery-receiving cavity for powering the motor of the base unit.

2. The appliance of claim 1, wherein the battery is a 12V battery.

3. The appliance of claim 1, including:
a second lid assembly contemplated to be interchangeable with the first lid assembly, wherein the second lid assembly is configured to be coupled to the upper collar of the blender jar, and further wherein the second lid assembly includes a cap member removably received on an open aperture of the second lid assembly.

4. The appliance of claim 3, wherein the second lid assembly includes a handle disposed thereon.

5. The appliance of claim 4, wherein the handle is disposed on the cap member.

6. The appliance of claim 5, wherein the handle is operable between deployed and stowed positions on the cap member.

7. The appliance of claim 3, wherein the upper collar of the blender jar includes one or more locking members inwardly extending from an inner surface thereof.

8. The appliance of claim 7, wherein the first lid assembly and the second lid assembly each include one or more engagement channels in which the locking members of the blender jar are received with a 45° or less rotation thereof.

9. An appliance, comprising:
a base unit having a housing with an upwardly opening upper cavity with a drive connection positioned therein, wherein the housing further includes a battery-receiving cavity;
a motor disposed within the housing of the base unit;
a blender jar having an upper collar and an interior cavity;
a lid assembly having first and second collars disposed on opposite sides of a divider;
wherein the first collar surrounds a drive connecting member positioned on a first side of the divider and is removeably coupled to the upper cavity of the base unit, and further wherein the second collar surrounds a blade assembly on a second side of the divider and is removeably coupled to the upper collar of the blender jar, and further wherein the drive connecting member engages the drive connection of the base unit when the lid assembly is coupled to the upwardly opening upper cavity of the base unit at the first collar thereof; and
a battery removably received within the battery-receiving cavity for powering the motor of the base unit.

10. The appliance of claim 9, wherein the first collar includes at least one connecting member provided on an outer surface thereof.

11. The appliance of claim 10, wherein the upper cavity of the base unit includes at least one alignment tab provided therein to releasably receive the at least one connecting member.

12. The appliance of claim 9, wherein the second side of the divider includes a plurality of ramps outwardly extending therefrom, and further wherein each ramp includes an angled upper surface that is disposed in a curved configuration.

13. The appliance of claim 12, wherein the blade assembly includes a plurality of blades outwardly extending from a baseplate, wherein one or more blades of the plurality of blades includes a distal end that extends towards the second side of the divider for rotation along a rotational path.

14. The appliance of claim 13, wherein each ramp of the plurality of ramps is disposed in a curved configuration that is aligned with the rotational path.

15. The appliance of claim 9, wherein the battery is a 12V battery.

16. An appliance, comprising:
a base unit having a housing with an upwardly opening upper cavity with a drive connection positioned therein, wherein the housing further includes a battery-receiving cavity;
a motor disposed within the housing of the base unit;
a blender jar having an upper collar and an interior cavity;
a lid assembly having first and second collars disposed on opposite sides of a divider;
wherein the first collar surrounds a drive connecting member positioned on a first side of the divider and is configured to be coupled to the upper cavity of the base unit, and further wherein the second collar surrounds a blade assembly on a second side of the divider and is configured to be coupled to the upper collar of the blender jar; and
a battery removably received within the battery-receiving cavity for powering the motor of the base unit.

17. The appliance of claim 16, wherein the base unit includes a sidewall surrounding an interior cavity, wherein the sidewall includes a collar outwardly extending therefrom, wherein the collar surrounds the battery-receiving cavity.

18. The appliance of claim 17, wherein the collar of the base unit includes notches disposed on opposite sides thereof, and further wherein the battery includes tabs that engage the notches of the collar when the battery is received in the battery-receiving cavity.

19. The appliance of claim 18, wherein the battery-receiving cavity includes a number of terminals that are positioned within a terminal receptacle that inwardly extends towards the interior cavity of the base unit.

20. The appliance of claim 19, wherein the battery is a 12V battery, and further wherein the battery includes a plug that outwardly extends from a rear surface of the battery, wherein the plug is removeably received in the receptacle of the battery-receiving cavity.
